(19) United States
(12) Patent Application Publication
(10) Pub. No.: US 2023/0196194 A1
(43) Pub. Date: Jun. 22, 2023

(54) COMPUTER PROGRAM PRODUCT AND ARTIFICIAL INTELLIGENCE TRAINING CONTROL DEVICE

(71) Applicant: Hitachi Astemo, Ltd., Hitachinaka-shi, Ibaraki (JP)

(72) Inventors: Ioannis SOUFLAS, London (GB); Noyan SONGUR, London (GB)

(73) Assignee: Hitachi Astemo, Ltd., Hitachinaka-shi, Ibaraki (JP)

(21) Appl. No.: 17/926,939

(22) PCT Filed: Feb. 25, 2021
(86) PCT No.: PCT/JP2021/007110

§ 371 Date: Nov. 21, 2022

(30) Foreign Application Priority Data
May 25, 2020 (DE) 10 2020 206 433.4

(51) Int. Cl. G06N 20/00

(52) U.S. Cl. CPC G06N 20/00

(57) ABSTRACT

A computer program product comprising computer-readable instructions that, when executed in a computer system including one or more computers, cause the computer system to receive a data set of a machine driven by a human or robot driver; condition said data set by grouping the data based on predefined or definable machine-control parameters; search the conditioned data for determining data imbalances within groups or sub-groups of the conditioned data; balance the data for which an imbalance was determined; and output the balanced data.

The present disclosure relates to a computer program product comprising computer-readable instructions that can be executed in a computer system including one or more computers and an artificial intelligence training control device. An optimized safe artificial intelligence can be generated in a transparent way while the disclosed process for generating said artificial intelligence is less complex and more efficient so that computing costs and/or user interaction can be reduced. Machines handled may include autonomous vehicles, such as passenger cars, buses, shuttles, as well as other entities which are driven along a trajectory, such as delivery robots.

### BACKGROUND

Data input to an artificial intelligence handling a machine is often used in the context of autonomous vehicles controlled by the artificial intelligence. Sensor data, for example, images of camera sensors installed at the vehicle are input to the different layers of the artificial intelligence which then outputs driving instructions based on the information provided in the images. WO 2019/245618 A1 reports that the sensor images are pre-processed (before inputting it into the artificial intelligence) for reducing noise, e.g., using a conventional filtering system or the data is processed to input it into different layers of the artificial intelligence. However, it is not considered that the artificial intelligence itself may have been generated based on biased raw data sets. For example, in case the drivers from whom the training data for the artificial intelligence training data was created had an unsafe driving behavior or the driving courses were not balanced or the like, the artificial intelligence adopts said behavior. Optimization in view of safety, in particular, is therefore desired. However, complexity and computing costs of optimizing data sets which are intended to be used as training data sets of an AI are high. Without such optimization of data, before it is used for the training of an artificial intelligence, a safely behaving artificial intelligence is difficult to achieve.

### Problem and Solution

It is an object of the herein described disclosure to provide a solution which, in particular, includes a computer program product and an apparatus which allow to enable an optimized artificial intelligence (AI) for safely handling a machine, preferably a vehicle. Especially, the solution shall enable a semi-automated or fully automated, less complex optimization of the behavior of an artificial intelligence handling a machine. This is solved by the appended claims.

The following aspects are in particular provided:

A computer program product which may comprise computer-readable instructions that, when executed in a computer system including one or more computers, cause the computer system to perform following steps. The steps described in the following may also be considered as a method.

One or more data sets (raw data) of a machine may be received by the computer or computer system on which the computer program product is run. The machine may be controlled/driven by a human or a robot. Preferably, for example if the machine is a vehicle, such as a car, each data set may comprise of driving trajectories or each data point may represent one driving trajectory.. A trajectory may be a driving course from a start point to an end point or subsections thereof. The raw data may be inputted into the computer system by way of an interface or input unit. The data transmission may be performed via a network, on a data storage device, wireless or via a wired connection.

The raw data received may stem from sensors of the machine; if it is a vehicle, e.g., from trajectory generation devices, position identification systems, such as GPS or Galileo, sensors of the vehicle, and the like.

Further, conditioning of the data may be performed. The data to be conditioned may be the received raw data and/or the data to be conditioned may be raw data that was pre-processed before the conditioning. The pre-processing of raw data before the conditioning will be described further below. Conditioning may preferably describe one or more steps of a sub-process with which the data to be conditioned is structured, which may also be called sorting, categorizing, putting into groups, assigning to one or more groups or grouping. In other words, the data may be grouped and the grouping may be performed based on machine-control parameters (briefly called “parameters”, “attributes” or “features”). Preferably, the conditioning is performed so that the conditioned data is grouped hierarchically in a tree-like structure.

The machine-control parameters may be predefined and stored in a memory of the computer system or they may be defined by the user at the very moment of the conditioning step when prompted by the computer program product. In the latter case, the user may be prompted by way of a visual request displayed on a display unit or the like to input the information. The machine-control parameters will be discussed in more detail later, however, for a vehicle, e.g., they may include parameters related to the driving of the vehicle, such as speed, yaw rate, etc., and/or parameters of the driving environment of the vehicle or the like, such as shape of the maneuver, etc.

With regard to the optional pre-processing of the raw data different options are especially preferred. Said pre-processing is explained based on an exemplary raw data set. The raw data set may include data points of a plurality of trajectories driven by the machine/vehicle and each data point may (be) represent(ed) by values indicating coordinates of a position. Furthermore, the data set may include data measured by a machine sensor, such as speed (at each position of each trajectory). Said measured sensor data may be related to the data points. (1) A part of the machine-control parameters, such as a shape of the driving maneuver, lateral acceleration or the like, may be extracted from the raw data during the pre-processing step by calculating it based on data points of the driving trajectories. For example, it may be determined that a turn was driven in a part of a trajectory if the positions of a set of data points describe the shape of a turn. The calculation may be done by an extraction unit (or a subunit thereof) of the computer program, preferably, using heuristic criteria and/or unsupervised learning. (2) Other machine-control parameters, especially the machine-control parameters which are stemming from sensors, such as speed, may not require the pre-processing. They may be (simply) extracted from the data set. The extraction of the parameters may be automated. For example, the raw data set may be automatically searched and filtered by the computer program product according to the predefined or input machine-control parameters. For example, automatic extraction of the raw data may search for data in the raw data set which belongs to a first machine-control parameter, a second machine-control parameter, and the like.

Further, the conditioned data may be searched for finding or determining imbalances with regard to the distribution of the data over one or more groups or subgroups. In the context of data imbalances it may also be referred to deviations. The searching of imbalances preferably includes comparing data groups or sub-groups with each other for finding differences/deviations between the compared groups.

Further, the conditioned data may be balanced by removing the determined imbalance(s) and the balanced data may be output. Preferably, the balanced data may be output to a training unit of a training apparatus for an artificial intelligence (or machine controlled by an AI) and/or to a user by way of a display unit. If the “training unit” is included in the computer program product or if the steps before the outputting are performed by a single is device, “outputting” may rather mean sending the balanced data to the internal training unit. The outputting to the user may be beneficial for the user to validate the result of the steps described above. The validation may for example include displaying the raw data set(s) and the balanced data so that the user can evaluate the differences and/or the effect of the optimization.

The output of the computer program product can be generated by a semi-automated or a fully automated process during which the raw data received from a machine, such as a vehicle driven by a human or robot driver, is processed such that an uttermost safe improved automated machine can be realized; preferably an artificial intelligence which controls said machine is trained with the output of the above described computer program product or method. The complexity of the process is reduced in view of different dimensions: If the user input is requested in a semi-automated process, the user's convenience is increased because he/she is guided by the computer program product and output to the user can be tailored so that the information is easily interpretable and complex processing steps are automated; if the process is fully automated, the process flow of the steps described above is assembled to reduce the required computing resources by neatly processing the raw data step by step, each step resulting in an intermediate product which can be processed efficiently by the unit performing the next step. In other words, especially the steps of conditioning and then balancing the datasets allow reducing the complexity of the computing process, i.e. reducing overload of computing resources or reducing the need for high-end computing resources. The conditioning is a process which can be carried out by a known computer system efficiently and, afterwards, the conditioned data structure allows quick recognizing of imbalances and balancing thereof. Therefore, the steps of conditioning and balancing bring technical effects reducing required computing power and, at the same, allow providing balanced data which enables providing of a safer AI. Furthermore, the output, i.e. the balanced data, is optimized such as to reduce the computing efforts required for the training of the AI which also lowers the complexity.

In a further preferred aspect, the hierarchical grouping (step), i.e. the conditioning, may include sorting the data (raw and/or pre-processed data) into groups and sub-groups. Hierarchical grouping preferably returns a tree-like structure of interlinked groups and sub-groups arranged on different levels of the data structure. The imbalance determination or detection may preferably include the step of comparing a number of data points/samples is of groups or sub-groups with each other. The detection of an imbalance may be returned if a difference between the number of data points/samples of groups or sub-groups compared with each other is larger than a predefined threshold. Alternatively, the amount/volume of data may be compared. If the data set(s) of the raw data include trajectories of a vehicle, it may also be compared, very preferably, the number of trajectories in the compared groups. More preferably, the groups or sub-groups of each level of the tree-like structure are compared with each other (within one level) and the part of the group with the lowest number of data sets/points is determined to have an imbalance, even more preferably if in addition the difference is greater than the predefined threshold. If no predefined threshold is used, in each level of the conditioned data the group or sub-group with the lowest number of data sets may be selected as an imbalance.

If however the threshold is applied, the imbalance is only detected if in addition the difference is greater/smaller than the threshold.

The automated conditioning and imbalance detection allows to further improve the technical benefits of the above described aspect(s), especially reducing the computing costs for improving the raw data.

In a further preferred aspect, the machine-control parameters, such as the data relating to the driving of a vehicle (driving parameters), may be contextual parameters or statistical parameters. Based on these two categories, groups and sub-groups are definable and which may be connected to each other in a tree-like arrangement. Each level of the tree-like structure may have one or more groups (or subgroups) and each successive/next lower level may have additional groups connected to a group of the next higher level.

Further, groups or sub-groups of raw data and/or pre-processed data including contextual parameters may be divided into one or more clusters of data. Groups or sub-groups of raw data including statistical parameters may be divided into one or more bins of data. The number of bins or clusters per group may vary from group to group. The number of bins or clusters per group may be predefined or may be set by a user after being prompted to enter the number.

In other words, the conditioned data may be arranged to have either contextual parameters or statistical parameters provided in a group or sub-group. Within the hierarchically arranged conditioned data each bin or cluster of a group or sub-group may be linked with one or more bins or clusters of the next lower level sub-group.

In a further aspect, the conditioned data may have a number of hierarchically arranged groups and sub-groups, arranged on different levels starting at the highest level (the highest level group) and sub-groups linked to the highest level group in lower levels. Each group or sub-group may be divided into one or more clusters of data (or one or more bins of data depending on the type of parameter selected for said group/sub-group). The machine-control parameters may either be contextual or statistical parameters and each machine-control parameter may be associated with one or more clusters (or one or more bins) of a group or sub-group. The data relating to contextual parameters is sorted into clusters and the raw data relating to statistical parameters is sorted into bins.

For example, if, for the highest level group, the parameter “speed” is chosen by the user or automatically selected according to a predefined structure, it is detected that “speed” is a statistical parameter. Therefore, data exhibiting speed values will be grouped into the highest level group for which the parameter “speed” was selected. Since speed is a statistical parameter, the speed data is divided into bins within the highest level group. The number of bins can be selected by the user when prompted to do so or it can be predefined as well. The range of the speed values present in the data is then preferably evenly divided by the number of bins. For example, if four bins are selected and speeds would range from 0 to 100 km/h, the first bin would include the speed data with values between 0 to 25 km/h, the second bin would include the speed data with values between >25 to 50 km/h, and so on.

If a contextual parameter is selected, the related data is put into clusters and the number of clusters is preferably predefined, as shown in the Figures described below. Each sub-group linked at a lower level to the highest level group can again include data values arranged in bins or clusters depending on the parameter selected.

Further, if the number of clusters and bins per group or sub-group is predefined in a database, the number of clusters may be equal to the number of sub-parameters of the contextual parameter associated with the clusters, and depending on the number of bins associated with a statistical parameter, the range of values of the statistical parameter may be evenly distributed over the bins, as explained in the example above.

The conditioning can be performed fully automated based on, e.g., predefined data structures, or a user can define, with few inputs, a customized structure of the conditioned data. This allows, in the balancing step, that less complex processing operations are required and the outputted product, the balanced data, can be improved with regard to enabling a safe AI.

In a further preferred aspect, the machine is a vehicle and the sets of raw data include a plurality of trajectories driven by a human-controlled or robot-controlled vehicle. The raw data may be gained from multi-sensor data extraction, such as vehicle sensors, driving control including trajectory generator devices, position information systems, and the like. Further sources for the raw data are addable.

Preferably, not exhaustively listed in the following, contextual parameters may include turns and related sub-parameters, such as left turn, right turn, straight road and/or complex turn, obstacles, such as obstacle detected and/or no obstacle detected, driver actions, such as free cruising, lane changing, obstacle following and/or overtaking. Preferably, not exhaustively listed in the following, statistical parameters may include parameters, such as speed, yaw rate and/or accelerations.

The above technical benefits of the conditioning step likewise apply for the application scenario of a vehicle.

In a further preferred aspect, as described by way of example above, the hierarchical structure of groups and sub-groups as well as bins and clusters of the groups and sub-groups may be predefined and stored in a memory connected to the computer system or being part of the computer system. Alternatively or in addition, the structure may be editable by a user at the very moment of running the computer program product. In the case of the user editing the structure, the user may be at least prompted to input the number of groups and sub-groups (which preferably means the number of levels) as well as the number of bins or clusters per group or sub-group. In the latter case, the amount of input required by the user is reduced and at the same time the degree of customization is high.

In a further preferred aspect, if bins and clusters are included in the conditioned data, preferably an imbalance may be determined by comparing bins or clusters of a group or sub-group with each other for finding the bin or cluster with the lowest number of data points or the lowest number of driving trajectories. The balancing may be performed by a random under-sampling of all other bins or clusters in the group or sub-group (on the same level) to the number of data sets in the bin or cluster with the lowest number of data sets. Preferably, a minimum number of data sets is predefined, which, if the smallest bin or cluster does not include the minimum number, prevents a balancing. In case of a vehicle, the data number of trajectories is preferably compared. Such balancing neatly achieves a reducing of the computing costs because the operations are not complex while it also reinforces the safety of the AI being fed with the balanced data set.

Further, the balancing may be performed level by level following the hierarchical structure of the conditioned data from the highest level group to the lowest level sub-group (or vice versa) which results in an optimized workflow of the balancing process.

In a further preferred aspect, the raw data (as well as the pre-processed data), the conditioned data and/or the balanced data may be output to a user for validation of the conditioning and/or balancing operation. This allows human-based evaluation of the processed data so that a further level of safety can be added if a human user does a checking of the balanced and/or conditioned data. For quick and simple comparison, the raw data may be displayed, too.

Further, the data may be output to the user such that groups and sub-groups are arranged as concentric rings with different diameters, and the bins or clusters may be segments of the concentric rings which allows an even easier and quicker understanding/evaluation of the data in a very transparent manner.

In a further preferred aspect, the computer program product may be installed on a computer or distributed computing resources/storage spaces. The latter case may allow distributed involvement of different users or computing/storage resources. Again, the extraction of data from the sets of raw data, the conditioning, and/or the balancing may be automatically performed as described above.

In a further preferred aspect, an artificial intelligence training control device which at least may have a memory unit with the computer program product according to at least one of aspects described above stored therein, an input interface, an output interface and/or a display unit. The input interface may be configured to receive raw data from one or more data sources being connected to the input interface via a wired connection or a wireless connection. The input interface may be configured to accept only predefined data formats for further reducing complexity of the data processing. The output interface may be configured to output the balanced data. Outputting, as described above, may mean that the balanced data is input to a training unit being part of the AI training control device or, if it is external, to another entity which allows using the data for the training of an AI. Additionally, a display unit may be provided configured to display the raw data (and/or the pre-processed data), conditioned data and/or the balanced data to a user. Further, requests for inputting information/data may be displayed to the user as well.

Especially the use-case of an AI driver of a vehicle requires that autonomous vehicles are accepted as a reliable and safe transportation service. This requires the realization of a smooth, natural, human-like vehicle control. The plethora of driving data captured from modern cars is a key enabler therefor. The proposed solution including the automatic extraction of driving parameters following the conditioning and balancing can be used to update machine learning models responsible for vehicle motion planning and control. A semi-automated or fully automated, less complex, more efficient optimization of the behavior of the artificial intelligence safely handling a machine/vehicle is enabled.

### BRIEF DESCRIPTION OF DRAWINGS

FIG. 1 schematically shows a schematic comparison of a comparative device and a device according to the disclosure.

FIG. 2 schematically shows a preferred process/method of the disclosure.

FIG. 3 shows an example of categorized driving parameters.

FIG. 4 shows an example for conditioning of raw data according to the disclosure.

FIG. 5 shows an example for conditioning and balancing of data according to the disclosure.

FIG. 6 shows an example of an output to a user comparing raw data and balanced data according to the disclosure.

FIG. 7 schematically show examples for raw data which is well-distributed (FIG. 7a) or skewed (FIGS. 7b, 7c)

FIG. 8 schematically shows the behavior of an artificial intelligence vehicle driver if the raw data input was imbalanced in a comparative example.

FIG. 9 schematically shows the behavior of an artificial intelligence vehicle driver if the raw data was pre-processed based on the disclosure.

### DETAILED DESCRIPTION OF EXEMPLARY EMBODIMENTS

In the following, preferred aspects and examples will be described in more detail with reference to the accompanying figures. Same or similar features in different drawings and examples are referred to by similar reference numerals. It is to be understood that the detailed description below relating to various preferred aspects and preferred examples are not to be meant as limiting the scope of the present disclosure.

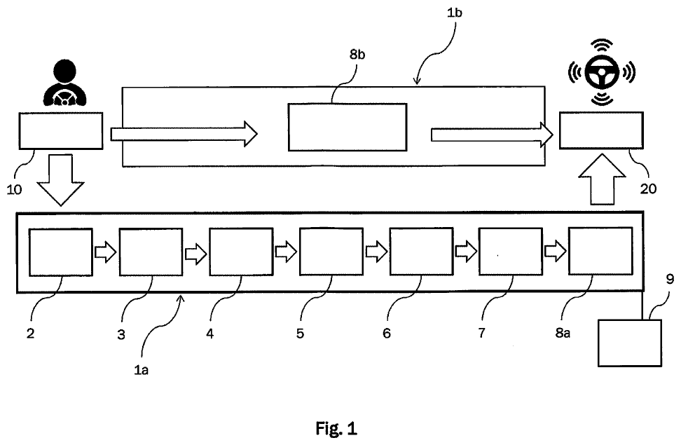

FIG. 1 shows a high-level overview over the herein described artificial intelligence (AI) training control device 1a which is depicted next to a comparative example of an AI training control device 1b. As the arrows indicate, the comparative example of an AI training control device 1b is fed with raw data stemming from a machine controlled or driven by a human or robot. As a preferred example, in the following description it will be assumed that the raw data originates from a machine which is a vehicle that is/was driven by a human or a robot along a plurality of trajectories. In the comparative example, the raw data is input into the training unit 8b of the comparative example and the output is a trained AI which can be input into an AI path planner 20 for realizing a self-driving vehicle. Compared thereto, the present disclosure is shown in the lower part of FIG. 1 and the AI training control device 1a has a different setup with additional sub-units which can output a more reliable and safer AI driver or a (balanced) data set to be fed into an external AI training unit 8a (if alternatively the unit 8a is arranged outside the device 1a which is not depicted in FIG. 1).

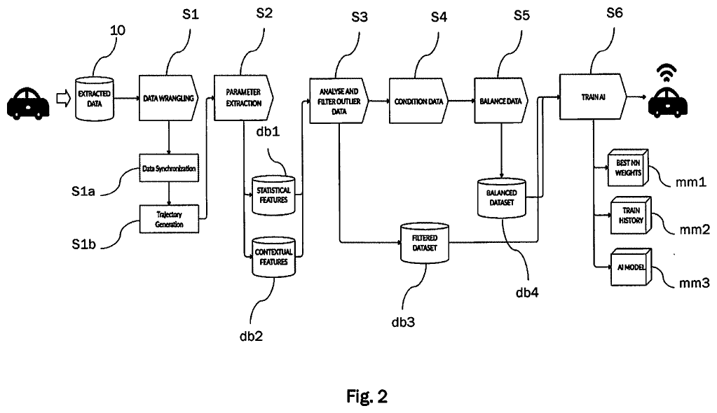

Specifically, FIG. 1 shows sub-units of the AI training control device 1a which processes the raw data/data set(s) 10. At first, the raw data is received by the input unit 2 which can be combined with “a synchronization unit” configured to receive and preferably synchronize the raw data stemming from a plurality of sensors which record the behavior of the human/robot controlling the machine. Subsequent to the receiving and synchronization of the raw data, the raw data is passed to the further units 3 and 4 being an analyzation data unit 4 and an extraction data unit 3. The units 3 and 4 may be a single combined unit. The analyzation performed in the analyzation data unit 4 is an optional process which is described in connection with FIG. 2.

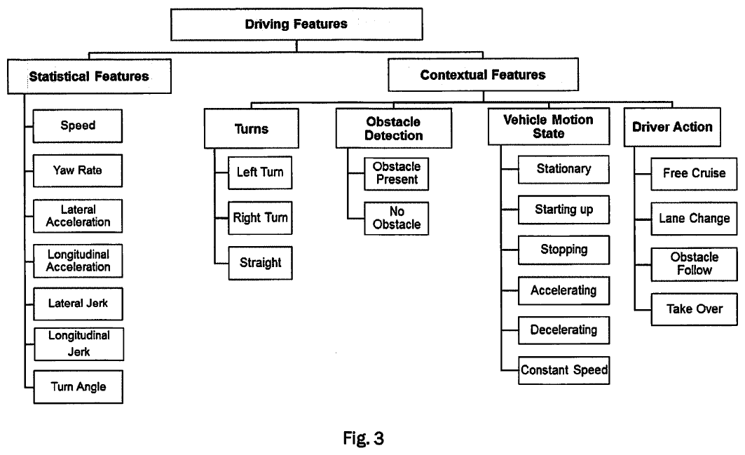

The extraction data unit 3 is configured to extract the data depending on the type of machine-control parameter to be extracted. Raw data stemming from vehicle sensors, e.g., may be directly used in the conditioning step. Thus, data related to these machine-control parameters for which predefined categories are available may be automatically extracted and passed to a grouping unit. The grouping unit may include the optional unit 5 as well as the unit 6 shown by FIG. 1.The predefined categories are the later described machine-control parameters. For example, the unit 3 may automatically determine that the raw data set 10 includes speed data of the vehicle for a plurality of trajectories which is then labelled/extracted accordingly. Furthermore, some machine-control parameters may require pre-processing of the underlying raw data using heuristic criteria and an unsupervised machine learning algorithm, such as k-means. For example, the acceleration or the driving maneuver of the vehicle (such as straight driving or driving of a turn) may need to be determined from the raw data, e.g. by comparing data points of the trajectories. Very preferably, each trajectory in the raw data set is labelled/extracted for every machine-control parameter (e.g. as shown by FIG. 3) after the extraction unit 3 has finished the processing.

The grouping unit may then receive the extracted data from the extraction unit 3 (or from the optional analyzation unit 4). An optional filter data extremities unit 5 of the grouping unit can be provided to detect and preferably to delete data outliers. Afterwards, the conditioning unit 6 of the grouping unit conditions/groups the data processed by the extraction unit 3, i.e. the raw data and/or the pre-processed data, based on the machine-control attributes/parameters (in case of a vehicle they may be called driving attributes/parameters). The conditioning will be explained in further detail below.

Subsequently, the conditioned data is sent to the balancing unit 7 which performs a correction of imbalanced data to be described later, too. Afterwards, the balanced data is input into a training unit 8a which can be part of the AI training control device 1a as shown in FIG. 1. Alternatively, the training unit 8a can be an external unit to which the data is output from the AI training control device 1a. Furthermore, a memory/database 9 may be connected to the AI training control device 1a or may be included in the device as well as not shown processors.

FIG. 2 now provides further details of the flow of the process along the units shown in FIG. 1. As shown, raw data 10 provided from a database or a memory, for example unit 9 as shown in FIG. 1, is input into the process starting with step S1. Step S1 may be named “data wrangling” and may be divided into sub steps S1a and S1b. The functionality can be allocated in the synchronization unit 2. The data wrangling includes processing the raw data 10 to perform optionally a time alignment of the raw data 10. Time alignment might be beneficial especially in case the data sources were sampled at different frequencies. Furthermore, the raw data 10, such as the human/robot driving data, may include a range of readings from vehicle dynamics to perception system variables (occupancy map, object detection, and the like). The data format of the input data may be predefined in a database or the like. After step S1a, data sequences may be generated following the above described synchronization of the raw data set. The length of the sequences and the direction (either directed to the past or future), are customizable by the user and may be determined by the user based on the machine's sensor architecture and/or specifications thereof. As a result, synchronized data/sequences are saved as arrays/trajectories. A trajectory of driving data may include specific driving/machine-control data at certain locations/time points and including several driving parameters, such as speed or the like. After step S1, including the sub-steps S1a and S1b as shown in FIG. 2, the process proceeds to step S2 being named “parameter extraction”, which takes place in the extraction unit 3.

Detailed description of the (machine-control) parameter extraction (or “feature extraction”): A list of driving/machine-control attributes/parameters which may be predefined in a database, such as database DB1 and database DB2 shown in FIG. 2, may be provided. An example is show in FIG. 3 (“driving features”). Instead of the graphical illustration, a respective table might be saved in the databases/memory 9 mentioned before. Generally, it is preferred that two main types of parameters are provided which are named “statistical” and “contextual”. The parameter extraction of step S2 may include a pre-processing based on heuristic criteria and based on an unsupervised machine learning algorithm, such as k-w means. As one can see from FIG. 3, the statistical parameters may include speed, yaw rate, lateral acceleration, longitudinal acceleration, lateral jerk, longitudinal jerk, and/or turn angle if the controlled machine is a vehicle as in the present example. Further parameters may be added or parameters may be left out if required. The contextual parameters may for example be categorized into turns including left turns, right turns, straight “turns” (maneuver), and other possible forms of the street. Further, obstacle detection may be a sub-category including present obstacles or no obstacles as well as vehicle motion state may be another sub-category including stationery, starting up, stopping, accelerating, decelerating, and/or constant speed. Furthermore, driver action may be another sub-category of contextual parameters including free cruise, lane change, obstacle follow and/or take over. As with the statistical parameters the number of sub-categories of the contextual parameters including their items may be increased or decreased depending on the specific requirements. Other machine-control parameters may be extracted directly from the raw data during step S2 without the pre-processing. For example, sensor-measured raw data, such as the speed of the vehicle, may be directly extracted during step S2.

Further, the control device 1a optionally enables the user to analyze the raw data or preprocessed data output by the extraction unit 3 using predefined and/or user definable statistical and contextual machine-control parameters. The extracted data may be displayed to the user so that the user may transparently analyze the data set. Even though FIG. 2 shows the data analyzation in combination with step S3, it may also be part of step S2.

Before explaining the analyzation of step S3, an exemplary software architecture of the herein described disclosure shall be explained: A front end functionality is provided by known tools. Further, the back end may be divided into a data wrangling, analysis, filtering and balancing part as well as an AI training and analysis part. For example, if the analyzation performed in the course of S2 or S3 uses back end libraries, for preliminary statistical understanding, time-aligned samples may be read and saved into data frames containing driving course/trip id, data sample id, GPS coordinates and speed, yaw rate, longitudinal and lateral acceleration values. The toolbox then allows the user to GPS-synchronize the data samples and visualize different parameter trends across different trips and drivers in forms of histogram, scatter plots and GPS map. Based on these, after being output to the user on a display unit, the user can compare drivers, understand data variances and detect outliers. Furthermore, the toolbox may provide a more contextual understanding by providing information about number of turns, obstacle detection, type of driving maneuver and vehicle motion state if the controlled machine is a vehicle. Such detailed data analysis provided by the analysis unit 4 (see step S3 in FIG. 2) may help the user to understand the underlying driving behavioral traits prior to any training activities of AI-driven autonomous vehicles.

The analyzing and filtering of outliers in the raw/pre-processed data is performed at step S3 and is thus preferably performed after step S2, i.e. the extraction of the parameters/features.

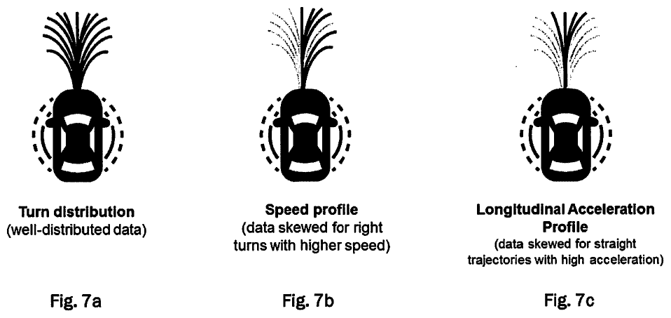

For enabling a further optimized and even safer AI self-driving, the data of the present disclosure is conditioned and balanced on a multitude of parameter spaces. An example is shown in FIG. 7 schematically which shows different trajectories of raw datasets 10. For example, FIG. 7a shows a well-distributed raw data set 10 for a turn distribution while FIG. 7b shows a speed profile with an imbalance to the right side as shown by the different trajectories departing from the middle line and FIG. 7c shows an imbalanced dataset with regard to longitudinal acceleration profiles. Once the user has identified data biases and extremities or an AI of the control device did so automatically itself, it is possible to filter out these biases based on parameter minimums and maximums. Therefore, it can be ensured that the resulting AI driver will not behave in a manner that will exceed limits of save driving.

In more detail, the conditioning and balancing steps S4 and S5 of FIG. 2 are performed after the data was extracted by the extraction unit 3 (step S2). A predefined tree-like structure of the parameters or a structure of the parameters freely chosen by a user can be applied for conditioning the data in step S4.

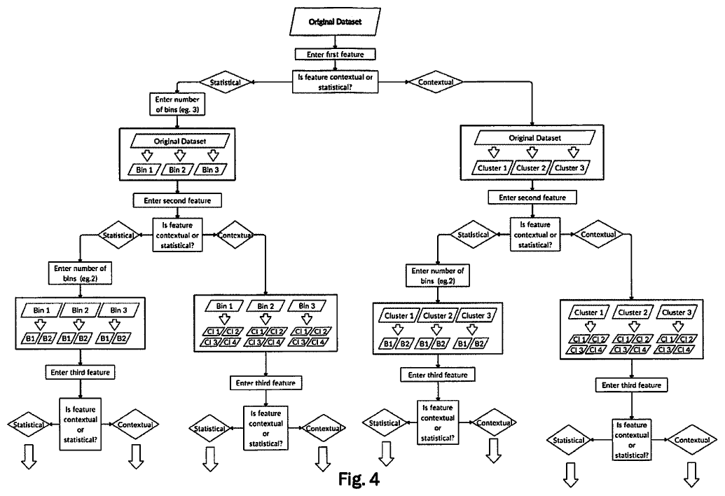

FIG. 4 shows a basic principle of the conditioning process of the data. In a first sub step of the conditioning, a first parameter is either selected by the user or it is automatically selected according to a predefined structure. Then, it is decided whether it is a statistical or a contextual parameter. For example, the speed of the vehicle is a statistical parameter and the driving maneuver is a contextual parameter. Then, depending on the type of the parameter, the data belonging to the first selected parameter can be further conditioned as described in the following. The data associated/belonging to the first control parameter forms the first group of the hierarchically structured conditioned data. For example, assuming that a statistical parameter was selected as the first machine-control parameter, the user is prompted to enter the number of bins or a predefined number of bins is applied. Then, the raw data belonging to the first parameter is divided into the number of bins. The distribution into the different bins is preferably performed by automatically segmenting said data into L equally spaced bins between the minimum and the maximum of the data. For example, if speed is selected as the first machine-control parameter and if three bins are used (as shown in FIG. 4) and if the maximum speed in the raw data being 30 m/s, segmentation would return that all data relating to speed among the raw data is put into a bin for speed values between 0 to 10 m/s, a bin for speed values between 10 and 20 m/s and a bin including the speed data between 20 and 30 m/s.

In another example, if a contextual parameter is selected as a first machine-control parameter, such as turns, the data is partitioned into the parameter's predefined clusters as described before and as shown in FIG. 3, for example. For turns, in this example of FIG. 3, the clusters would be left turn, right turn, and straight “turns”/streets/maneuver. Therefore, in this example, three clusters as shown in FIG. 4 would be created and the data would be assigned to the three clusters with regard to turn data depending on whether they relate to left, right turns or straight maneuvers.

The first machine-control parameter and the data sorted thereto forms the highest level group in the tree-like structure shown in FIG. 4. Further groups, i.e. sub-groups, may be added.

As shown in FIG. 4, a sub-group of the next level relating to a second parameter is added to the group of the highest level. The second parameter can be chosen by the user or can be predefined according to a predefined data structure. Then, as described for the highest level group, it is decided whether it is a statistical or contextual parameter and if it is a statistical parameter, the number of bins has to be defined by the user or is predefined. If it is another statistical parameter, sub-bins of the bins of the raw data belonging to the first parameter are generated. If the second is a contextual parameter, sub-clusters are added to the bins/clusters of the highest level group relating to the first parameter. This is depicted in the two left parts of FIG. 4 in the second level of the tree-like structure. Afterwards, as it is shown in FIG. 4, a third parameter may be added. Of course, even more than three parameters may be added. Analogously, second and third parameters may be added on the right side of the tree-like structure. Furthermore, in this example, the tree-like structure includes statistical and contextual first parameters which, however, may not need to be the case; instead, the chosen first parameter may either be statistical or contextual.

Assuming that the first parameter is a contextual parameter relating to turns and the second parameter is speed, it would result in sub-groups of speed being related/linked to the group of turns. In other words, in this example, the speed within left turns, right turns, and straight street, would be grouped as it is shown in the right side arm in the highest level in FIG. 4 and then in the left side arm of the contextual side arm in the second level group/sub-group of the first parameter.

After the conditioning, the step of balancing is performed (step S5) which results in a balanced dataset being storable in the database db4 as well as the filtered dataset can be stored in the database db3 of FIG. 2. The conditioned data may be balanced by under-sampling each sub-class to the lowest number of available samples contained in one sub-class. For example, once data conditioning is completed, the data may be balanced by firstly determining the lowest number of trajectories/datasets in any sub-group, and secondly, randomly under-sampling all other sub-groups to said lowest number. More specifically, the number of datasets in a bin or cluster of one group or sub-group may be compared with each other and the bin or cluster with the lowest number of datasets may be selected as the bin or cluster based on which number of datasets the under-sampling is performed. Furthermore, the detection of an imbalance leading to the balancing operation may be restricted to the case that the number of datasets in the compared bins/clusters is different to a predefined extend, e.g., an imbalance may only be determined if a bin or cluster of the compared bins or clusters has a deviation in regard of the number of datasets being larger/smaller than a predefined threshold. By this threshold it can be avoided that balancing/under-sampling is performed even if only small deviations between compared bins or clusters are present.

After the balanced data/dataset is created and stored in the database db4, a further step S6, training the AI, can be performed. The data created/used during the training including best weights, training history and/or the AI model by be stored in further storage spaces, such as shown by mm1 to mm3 in FIG. 2.

The above steps allow data to be balanced on a multi-feature dimension achieving conditional uniformity between contextual and statistical feature spaces. Based on the data size, a user can condition data to the as many numbers of parameters as possible to achieve balance in the highest number of parameter space. By balancing the dataset, the user can ensure that the trained AI agent/controller will have a uniform behavior spectrum in the balanced feature dimensions. If the user does not perform the conditioning, the conditioning can be carried out automatically, e.g., by using predefined conditioning structures. More specifically, if driving data of a vehicle shall be conditioned, the device 1a may have predefined conditioning structures indicating the first parameter, the second parameter, etc. as well as the number of bins or clusters for each group and sub-group, etc.

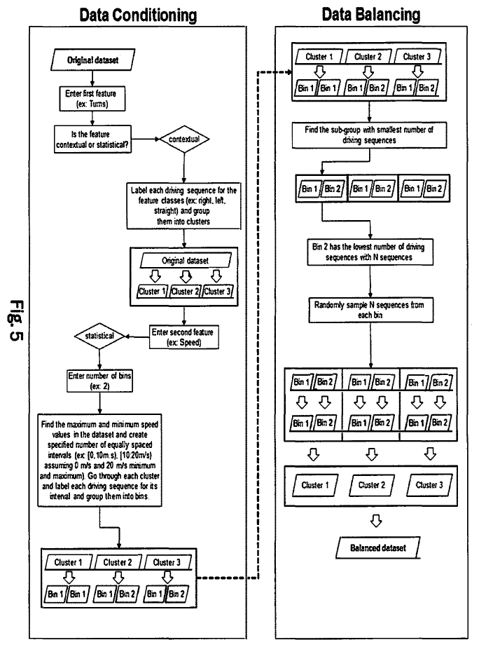

A specific example for the steps of conditioning and balancing is shown in FIG. 5 which includes the data conditioning as previously described with two parameters being selected.

The such conditioned data is then input to the data balancing in which, in this example, three clusters of turns related data are each subdivided into two bins relating to speed data. Then, it is checked which of the bins of the three clusters has the smallest number of driving sequences/trajectories/data points which in this example shall be bin no. 2.Then, assuming that L sequences/trajectories are included in bin no. 2, the other bins are under-sampled down to L sequences/trajectories each. As shown in the further flow of the process in FIG. 5, a balance data set is achieved.

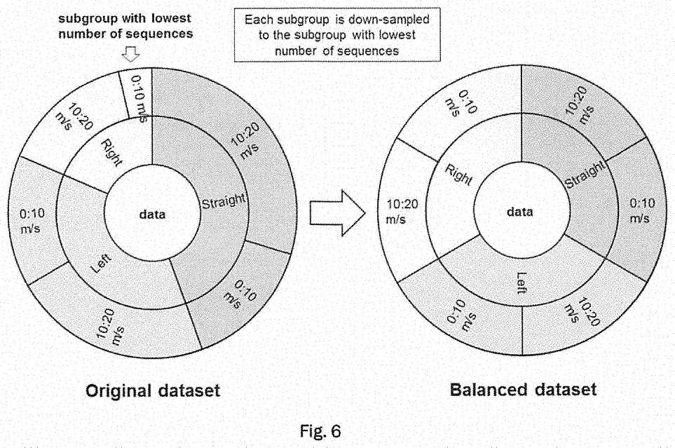

Furthermore, FIG. 6 shows an example of a possible data output to the user comparing the original dataset/raw data with the balanced data/dataset. As one can see in this example as indicated also by the arrow, the number of data points for speed in right turns for speeds between 0 and 10 m/s has the lowest number of data points/trajectories. Therefore, as shown in the balanced dataset, all other speed datasets for left, straight, and right turns and for all data ranges of the speed are adapted to include as many data points as the dataset between 0 and 10 m/s for right turns.

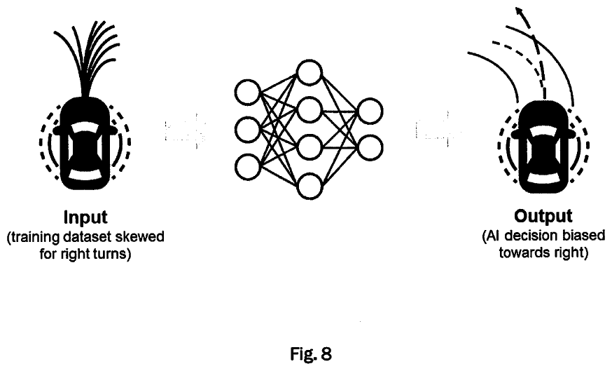

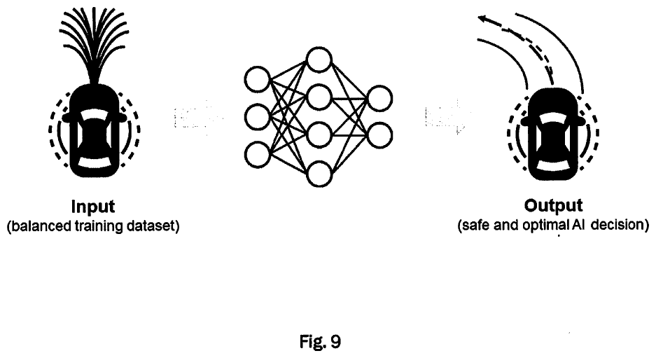

The effect of an unbalanced or balanced data (set) with regard to the driving behavior of the AI driver is schematically illustrated in FIGS. 8 and 9. FIG. 8 shows from the left to the right that an imbalanced raw dataset 10 is input into an AI training module and the output would then be a biased AI behavior towards right turns. As shown in the example of FIG. 8, if there are not enough learning data for a low speed curve to the left with a small radius, the vehicle being driven by a trained AI could not (safely) make a left turn in a respective sharp curve because of interference output is mainly available for curves with large radius and generally there is less data for left curves available in the example of FIG. 8. In other words, the safety of an unbalanced dataset, which can be visually be determined in the left part of FIG. 8 based on the lack of left turn trajectories (especially with a small radius) compared to the trajectories for right turns, may lead to an AI driver which may not be able to perform driving maneuvers safely. Analogously, FIG. 9 shows the technical effect of the AI training control device 1a as disclosed herein: A balanced dataset is created resulting in an optimal and safe AI driving behavior. Compared to FIG. 8, FIG. 9 has an even distribution of trajectories in the left hand side schematic indicating a balanced data set. One of the effects is that the AI driver is able to perform any driving maneuver safely.

As will be appreciated by one of skill in the art, the present disclosure, as described hereinabove and the accompanying figures, may be embodied as a method (e.g., a computer-implemented process or any other process), apparatus (including a device, machine, system, computer program product, and/or any other apparatus), or a combination of the foregoing.

Aspects/Examples of the present disclosure may be a software entirely (including firmware, resident software, micro-code, etc.), or a combination of software and hardware aspects that may be referred to as a “system”. Furthermore, the present disclosure may take the form of a computer program product on a computer-readable medium having computer-executable program code embodied in the medium.

It should be noted that arrows may be used in drawings to represent communication, transfer, or other activity involving two or more entities. Double-ended arrows generally indicate that activity may occur in both directions (e.g., a command/request in one direction with a corresponding reply back in the other direction, or peer-to-peer communications initiated by either entity), although in some situations, activity may not necessarily occur in both directions.

Single-ended arrows generally indicate activity exclusively or predominantly in one direction, although it should be noted that, in certain situations, such directional activity actually may involve activities in both directions (e.g., a message from a sender to a receiver and an acknowledgement back from the receiver to the sender, or establishment of a connection prior to a transfer and termination of the connection following the transfer). Thus, the type of arrow used in a particular drawing to represent a particular activity is exemplary and should not be seen as limiting.

The present disclosure may be described with reference to flowchart illustrations and/or block diagrams of methods and apparatuses, and with reference to a number of sample views of a graphical user interface generated by the methods and/or apparatuses. It will be understood that each block of the flowchart illustrations and/or block diagrams, and/or combinations of blocks in the flowchart illustrations and/or block diagrams, as well as the graphical user interface, can be implemented by computer-executable program code.

The computer-executable program code may be provided to a processor of a general purpose computer, special purpose computer, or other programmable data processing apparatus to produce a particular machine, such that the program code, which executes via the processor of the computer or other programmable data processing apparatus, create means for implementing the functions/acts/outputs specified in the flowchart, block diagram block or blocks, figures, and/or written description.

The computer-executable program code may also be stored in a computer-readable memory that can direct a computer or other programmable data processing apparatus to function in a particular manner, such that the program code stored in the computer readable memory produce an article of manufacture including instruction means which implement the function/act/output specified in the flowchart, block diagram block(s), figures, and/or written description.

The computer-executable program code may also be loaded onto a computer or other programmable data processing apparatus to cause a series of operational steps to be performed on the computer or other programmable apparatus to produce a computer-implemented process such that the program code which executes on the computer or other programmable apparatus provides steps for implementing the functions/acts/outputs specified in the flowchart, block diagram block(s), figures, and/or written description. Alternatively, computer program implemented steps or acts may be combined with operator or human implemented steps or acts in order to carry out an embodiment of the disclosure.

It should be noted that terms such as “server” and “processor” may be used herein to describe devices that may be used in certain aspects of the present disclosure and should not be construed to limit the present disclosure to any particular device type unless the context otherwise requires. Thus, a device may include, without limitation, a bridge, router, bridge-router (brouter), switch, node, server, computer, appliance, or other type of device. Such devices typically include one or more network interfaces for communicating over a communication network and a processor (e.g., a microprocessor with memory and other peripherals and/or application-specific hardware) configured accordingly to perform device functions.

Communication networks generally may include public and/or private networks; may include local-area, wide-area, metropolitan-area, storage, and/or other types of networks; and may employ communication technologies including, but in no way limited to, analog technologies, digital technologies, optical technologies, wireless technologies (e.g., Bluetooth), networking technologies, and internetworking technologies.

It should also be noted that devices may use communication protocols and messages (e.g., messages created, transmitted, received, stored, and/or processed by the device), and such messages may be conveyed by a communication network or medium.

Unless the context otherwise requires, the present disclosure should not be construed as being limited to any particular communication message type, communication message format, or communication protocol. Thus, a communication message generally may include, without limitation, a frame, packet, datagram, user datagram, cell, or other type of communication message.

Unless the context requires otherwise, references to specific communication protocols are exemplary, and it should be understood that alternatives may, as appropriate, employ variations of such communication protocols (e.g., modifications or extensions of the protocol that may be made from time-to-time) or other protocols either known or developed in the future.

It should also be noted that logic flows may be described herein to demonstrate various aspects of the disclosure, and should not be construed to limit the present disclosure to any particular logic flow or logic implementation. The described logic may be partitioned into different logic blocks (e.g., programs, modules, functions, or subroutines) without changing the overall results or otherwise departing from the true scope of the disclosure.

Often, logic elements may be added, modified, omitted, performed in a different order, or implemented using different logic constructs (e.g., logic gates, looping primitives, conditional logic, and other logic constructs) without changing the overall results or otherwise departing from the scope of the disclosure.

The present disclosure may be embodied in many different forms, including, but in no way limited to, a graphical processing unit as well as computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof Computer program logic implementing some or all of the described functionality is typically implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAs.

Computer program logic implementing all or part of the functionality previously described herein may be embodied in various forms, including, but in no way limited to, a source code form, a computer executable form, and various intermediate forms (e.g., forms generated by an assembler, compiler, linker, or locator).

Source code may include a series of computer program instructions implemented in any of various programming languages (e.g., an object code, an assembly language, or a high-level language such as Fortran, python, C, C++, JAVA, JavaScript or HTML) for use with various operating systems or operating environments. The source code may define and use various data structures and communication messages. The source code may be in a computer executable form (e.g., via an interpreter), or the source code maybe converted (e.g., via a translator, assembler, or compiler) into a computer executable form.

Computer-executable program code for carrying out operations of embodiments of the present disclosure may be written in an object oriented, scripted or unscripted programming language such as Java, Perl, Smalltalk, C++, or the like. However, the computer program code for carrying out operations of aspects of the present disclosure may also be written in conventional procedural programming languages, such as the “C” programming language or similar programming languages.

Computer program logic implementing all or part of the functionality previously described herein may be executed at different times on a single processor (e.g., concurrently) or may be executed at the same or different times on multiple processors and may run under a single operating system process/thread or under different operating system processes/threads.

Thus, the term “computer process” refers generally to the execution of a set of computer program instructions regardless of whether different computer processes are executed on the same or different processors and regardless of whether different computer processes run under the same operating system process/thread or different operating system processes/threads.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies.

The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Any suitable computer readable medium may be utilized. The computer readable medium may be, for example but not limited to, an electronic, magnetic, optical, electromagnetic, infrared, or semiconductor system, apparatus, device, or medium.

More specific examples of the computer readable medium include, but are not limited to, an electrical connection having one or more wires or other tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device.

The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies.

The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the disclosure may be implemented as a combination of both software (e.g., a computer program product) and hardware. Still other aspects of the present disclosure are implemented as entirely hardware, or entirely software.

While certain exemplary aspects have been described and shown in the accompanying drawings, it is to be understood that such embodiments are merely illustrative of and are not restrictive on the broad disclosure, and that the aspects of the present disclosure are not limited to the specific constructions and arrangements shown and described, since various other changes, combinations, omissions, modifications and substitutions, in addition to those set forth in the above paragraphs, are possible.

Those skilled in the art will appreciate that various adaptations, modifications, and/or combination of the just described aspects and examples can be configured. Therefore, it is to be understood that, within the scope of the appended claims, the disclosure may be practiced other than as specifically described herein. For example, unless expressly stated otherwise, the steps of processes described herein may be performed in orders different from those described herein and one or more steps may be combined, split, or performed simultaneously. Those skilled in the art will also appreciate, in view of this disclosure, that different aspects or examples of the disclosure described herein may be combined to form other aspects or examples of the disclosure.

1. A computer program product comprising computer-readable instructions that, when executed in a computer system including one or more computers, cause the computer system to
receive a data set of a machine driven by a human or robot driver;
condition said data set by grouping the data based on predefined or definable machine-control parameters;
search the conditioned data for determining data imbalances within groups or sub-groups of the conditioned data;
balance the data for which an imbalance was determined; and
output the balanced data.

2. The computer program product according to claim 1, wherein the grouping includes sorting the data into hierarchically arranged groups and sub-groups, wherein, by comparing the number of data points of the groups or sub-groups with each other, an imbalance is determined if a difference of the number of data points included in the groups or sub-groups compared with each other is larger than a predefined threshold.

3. The computer program product according to claim 1, wherein the conditioned data have n hierarchically arranged groups and sub-groups, with N indicating the highest level group and N-1, N-2, . . . , N-n indicating sub-groups of lower levels, and each group or sub-group is divided into one or more clusters of data or one or more bins of data, wherein the machine-control parameters are either contextual or statistical parameters and each machine-control parameter is associated with one or more clusters or one or more bins of a group or sub-group, and wherein data relating to contextual parameters is sorted into clusters and data relating to statistical parameters is sorted into bins.

4. The computer program product according to claim 3, wherein the conditioned data is arranged to have either contextual parameters or statistical parameters provided in a group or sub-group, and in the hierarchically arranged conditioned data each bin or cluster of a group of sub-group can be connected to one or more bins or clusters of the next lower level sub-group.

5. The computer program product according to claim 1, wherein the machine is a vehicle and the received data includes data of a plurality of trajectories driven by the vehicle that is driven by a human or robot driver, wherein the contextual parameters include turns and related sub-parameters, such as left turn, right turn, straight road and/or complex turn, obstacles, such as obstacle detected and/or no obstacle detected, driver actions, such as free cruising, lane changing, obstacle following and/or overtaking, and the statistical parameters include parameters, such as speed, yaw rate and/or accelerations.

6. The computer program product according to at least claim 5, wherein, if the number of clusters and bins per group or sub-group is predefined in a database, the number of clusters is equal to the number of sub-parameters of the contextual parameter associated with the clusters, and depending on the number of bins associated with a statistical parameter, the range of values of the statistical parameter is evenly distributed over the bins.

7. The computer program product according to claim 1, wherein the hierarchical structure of groups and sub-groups as well as bins and clusters of the groups and sub-groups is predefined or is editable by a user, wherein in the latter case the user is at least prompted to input the number of groups and sub-groups as well as the number of bins or clusters per group or sub-group.

8. The computer program product according to claim 1, wherein an imbalance is determined by comparing bins or clusters of at least one group or sub-group with each other for finding the bin or cluster with the lowest number of data points in the group or sub-group, and the balancing is performed by a random under-sampling of all other bins or clusters in the group or sub-group to the number of data points in the bin or cluster with the lowest number of data points.

9. The computer program product according to claim 1, wherein the balancing of the conditioned data is performed level-by-level from the highest level group to the lowest level sub-group.

10. The computer program product according to claim 1, wherein the raw data, the preprocessed data, the conditioned data and/or the balanced data is output to a user for validation of the conditioning and/or balancing operation.

11. The computer program product according to claim 1, wherein the data is output to a user such that groups and sub-groups are arranged as concentric rings with different diameters, and the bins or clusters are segments of the concentric rings.

12. The computer program product of claim 1 installed on a distributed computing resources/storage spaces.

13. An artificial intelligence training control device which at least has a memory unit with the computer program product according to claim 1 stored therein, an input interface, an output interface and a display unit, wherein the input interface configured to receive one or more data sets from a data source being connected to the input interface via a wired connection or a wireless connection, the output interface configured to output the balanced data, the display unit configured to display the raw data, the preprocessed data, conditioned data and/or the balanced data to a user.
